(19) United States
(12) Patent Application Publication
(10) Pub. No.: US 2026/0129298 A1
(43) Pub. Date: May 7, 2026

(54) Field of View Correction Techniques for Shutterless Camera Systems

(71) Applicant: Google LLC, Mountain View, CA (US)

(72) Inventors: Hua Cheng, New Taipei City (TW); Youyou Wang, Cupertino, CA (US); Chucai Yi, Fremont, CA (US); Fuhao Shi, San Jose, CA (US); Chia-Kai Liang, Cupertino, CA (US)

(21) Appl. No.: 19/117,473

(22) PCT Filed: Oct. 4, 2022
(86) PCT No.: PCT/US2022/077517

§ 371 Date: Apr. 1, 2025

(51) Int. Cl. H04N 23/69; H04N 23/63; H04N 23/67

(52) U.S. Cl. CPC H04N 23/69; H04N 23/632; H04N 23/675

(57) ABSTRACT

Example embodiments relate to field of view correction techniques for shutterless camera systems. A mobile device displaying an initial preview of a scene being captured by an image capturing device of the computing device may determine a zoom operation configured to cause the imaging capturing device to focus on a target. The imaging capturing device is configured to change focal length when performing the zoom operation. While the image capturing device performs the zoom operation, the computing device may then map focal lengths used by the imaging capturing device to a virtual focal length such that a field of view of the scene remains consistent across image frames displayed by the display screen between the initial preview of the scene and the zoomed preview of the scene that focuses on the target and display the zoomed preview of the scene that focuses on the target.

### BACKGROUND

Many modern computing devices, such as mobile phones, personal computers, and tablets, include image capture devices (e.g., still and/or video cameras). The image capture devices can capture images that can depict a variety of scenes, including scenes that involve people, animals, landscapes, and/or objects. Some image capture devices are configured with telephoto capabilities.

### SUMMARY

Example embodiments presented herein relate to field of view (FOV) correction techniques for shutterless camera systems. To reduce undesirable viewing artifacts that can arise during auto-focus sweeps, a mobile device or another type of computing device may use camera parameter interpolation to apply FOV correction techniques that keep the field of view consistent across image frames being displayed by the device. When the camera used by the mobile device is shutterless with rows (or columns) of image frames readout in sequence, the mobile device may analyze real focal length and optical center on a per-row basis (or per-column basis) when applying FOV correction techniques to accommodate the different exposure intervals associated with the sequence readout.

Accordingly, in a first example embodiment, a computer-implemented method is provided. The method involves displaying, by a display screen of a computing device, an initial preview of a scene being captured by an image capturing device of the computing device, wherein the image capturing device is operating at an initial focal length when capturing the initial preview of the scene. The method also involves determining, by the computing device, a zoom operation configured to cause the imaging capturing device to focus on a target, wherein the imaging capturing device is configured to change focal length when performing the zoom operation. The method further involves, while the image capturing device performs the zoom operation, mapping focal lengths used by the imaging capturing device to a virtual focal length such that a field of view of the scene remains consistent across image frames displayed by the display screen between the initial preview of the scene and a zoomed preview of the scene that focuses on the target, and displaying, by the display screen of the computing device, the zoomed preview of the scene that focuses on the target.

In a second example embodiment, a mobile device is provided. The mobile device includes a display screen, an image capturing device, one or more processors, and data storage. The data storage has stored thereon computer-executable instructions, that, when executed by the one or more processors, cause the mobile device to carry out operations. The operations involve displaying, by the display screen, an initial preview of a scene being captured by an image capturing device of the computing device, wherein the image capturing device is operating at an initial focal length when capturing the initial preview of the scene. The operations also involve determining a zoom operation configured to cause the image capturing device to focus on a target, wherein the image capturing device is configured to change focal length when performing the zoom operation. The operations further involve, while the image capturing device performs the zoom operation, mapping focal lengths used by the image capturing device to a virtual focal length such that a field of view of the scene remains consistent across image frames displayed by the display screen between the initial preview of the scene and a zoomed preview of the scene that focuses on the target. The operations also involve displaying, by the display screen, the zoomed preview of the scene that focuses on the target.

In a third example embodiment, a non-transitory computer-readable medium comprising program instructions executable by one or more processors to cause the one or more processors to perform operations. The operations involve displaying, by the display screen, an initial preview of a scene being captured by an image capturing device of the computing device, wherein the image capturing device is operating at an initial focal length when capturing the initial preview of the scene. The operations also involve determining a zoom operation configured to cause the image capturing device to focus on a target, wherein the image capturing device is configured to change focal length when performing the zoom operation. The operations further involve, while the image capturing device performs the zoom operation, mapping focal lengths used by the image capturing device to a virtual focal length such that a field of view of the scene remains consistent across image frames displayed by the display screen between the initial preview of the scene and a zoomed preview of the scene that focuses on the target. The operations also involve displaying, by the display screen, the zoomed preview of the scene that focuses on the target.

In a fourth example embodiment, a system may include various means for carrying out each of the operations of the example embodiments above.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1A depicts a front and a side view of a digital camera device, according to one or more example embodiments.

FIG. 1B depicts rear views of a digital camera device, according to one or more example embodiments.

FIG. 2 depicts a block diagram of a computing system with image capture capability, according to one or more example embodiments.

FIG. 3 depicts a simplified representation of an image capture component capturing an image of a person, according to one or more example embodiments.

FIG. 4 depicts an image capturing device performing an autofocus (AF) technique, according to one or more example embodiments.

FIG. 5 is a block diagram of a mobile device configured to perform disclosed FOV correction techniques, according to one or more example embodiments.

FIG. 6 depicts a comparison between a real camera view and a virtual camera view modified via a FOV correction technique, according to one or more example embodiments.

FIG. 7 is a flow chart of a method for applying FOV corrections to image frames being captured by a camera system, according to one or more example embodiments.

FIG. 8A illustrates a focal length representation determined based on an average focal length of an exposure interval, according to one or more example embodiments.

FIG. 8B illustrates a focal length representation determined based on a focal length at the middle of an exposure interval, according to one or more example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein. Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Depending on context, a “camera” may refer to an individual image capturing device, or a device that contains one or more image capture components. In general, an image capturing device may include an aperture, lens, recording surface, and shutter, as described below: The terms “image” and “payload image” may be used herein to describe the ultimate image of the scene that is recorded and can be later viewed by the user of the camera. The terms “image frames” and “frame” may be used herein to represent temporarily stored depictions of scenes that are displayed for preview purposes or are captured and analyzed to determine one or more qualities of a scene prior to capturing a image (e.g., to determine what types of subjects are in a given scene, regions of interest within a given scene, appropriate exposure times, ambient light intensity, motion-blur tolerance, etc.).

Moreover, in some implementations, the image processing steps described herein may be performed by a camera device, while in other implementations, the image processing steps may be performed by a computing device in communication with (and perhaps controlling) one or more camera devices.

### I. Overview

Autofocus (AF) is a feature that allows digital cameras, smartphones, and other types of camera devices to automatically sharpen the image and focus on a specific spot or subject with little to no input from the user. There are different ways in which a camera can perform AF, including passive AF techniques (e.g., contrast-detection AF (CDAF) and phase-detection AF (PDAF)) and active or hybrid techniques (e.g., laser AF).

Some AF techniques involve automatic adjustment of the distance between the camera lens and the image sensor until the camera is operating at a focal length that brings a particular spot or subject into focus. For instance, a camera may sweep a lens between various positions relative to the image sensor until the camera's software determines that the target is in focus. The quick changes of focal length during AF can rapidly change the camera's FOV, which can result in the camera displaying image frames with breathing artifacts that might negatively impact the user's experience when using the camera to capture an image of the scene. In particular, as the camera performs AF, the image previews being displayed by the camera may appear to be captured from different perspectives due to the rapid focal length changes caused by the AF sweeps.

Example embodiments relate to FOV correction techniques, which may be performed by mobile devices and other computing systems to reduce breathing artifacts that can arise when a camera quickly adjusts focal lengths in order to focus upon a target or aspect within a scene. For instance, when the camera on a mobile device initiates AF sweeps to focus on a target in a scene, the mobile device may execute software that warps real focal lengths of the camera to a virtual focal length thereby enabling the mobile device to display image previews of the scene that remain consistent in FOV despite the camera's real FOV changing during the AF sweeps. By producing image previews that appear consistent in FOV as the camera performs AF, undesired viewing artifacts that are aesthetically unpleasing to a user can be removed and the camera can display image previews that appear consistent in FOV.

In addition, disclosed FOV correction techniques can be used for shutterless cameras where rows (or columns) of the image are readout in sequence rather than all at once. For instance, when a camera uses a rolling shutter, rows of the image sensor may be read out sequence rather than the entire image sensor being read simultaneously. In such instances, the mobile device may use per row camera parameter representations when performing disclosed techniques to accommodate real focal lengths that differ across scanlines of the image sensor. This way, the FOV correction techniques can be implemented in a manner that factors the sequential readout of scanlines.

To further illustrate, one example method may be performed using a camera (e.g., a camera system that is a component of a mobile device, such as a mobile phone, or a DSLR camera) and may involve the camera initially displaying a preview of a scene on a display screen with the camera operating at an initial focal length. To focus on a target positioned within the scene, the computing device may determine and implement a zoom operation that causes the camera to bring the target into focus. For instance, after detecting a target in the scene automatically or based on user input, the camera may perform AF sweeps until transitioning to a focal length that enables clear focus upon the target. In some instances, the target may move into the scene as the camera is already capturing a preview of the scene, which may trigger the AF technique.

For mobile devices and other types of camera devices, AF and other zoom operations may involve physically adjusting the distance between the image sensor and the lens. As such, these adjustments in focal length between the image sensor and the lens can cause image frames being displayed by the camera to have noticeably different FOVs when viewed by the user. To reduce undesired effects associated with changing FOVs across image frames, a computing device may implement disclosed FOV correction techniques, which may involve mapping the changing real focal lengths used by the camera across image frames to a fixed virtual focal length. By determining and mapping the real focal lengths determined for consecutive image frames to the fixed virtual focal length, the computing device can display image frames depicting the scene that appear consistent in FOV and stable as the camera performs the zoom operation (e.g., AF sweeps) to focus on the target. The computing device can then display and potentially capture an image of the zoomed previous of the scene that focuses on the target on the display screen in an overall smooth display that appears from the same fixed virtual view as the original depiction of the scene.

Disclosed FOV correction techniques can involve using a fixed virtual focal length that is determined based on a calibration model previously generated for the camera. For instance, the camera intrinsic and extrinsic parameters can be measured and mapped on some predefined VCM sample points (or optical image stabilization (OIS)-VCM sample points). The mappings can then be stored as part of the calibration model for the camera. In some cases, the calibration model for a camera is generated during the manufacturing process of a mobile device associated with the camera.

When performing disclosed FOV correction techniques, the computing device may obtain frame-based data for each image frame while the camera system performs AF sweeps, such as VCM and/or OIS data along with timestamps. With each image frame representing a unit of data processing, the frame-based data can be used to determine geometric data for the camera as the camera adjusts focal lengths during the AF sweeps. The computing device can use camera intrinsic interpolation and the calibration model to derive the camera's real focal length (and principle point) for each image frame. When the image frames contain multiple VCM samples with different timestamps, the computing device is able to infer the camera intrinsic parameters based on the different timestamps using camera intrinsic interpolation and the calibration model.

After deriving the real focal length(s) for an image frame based on camera intrinsic interpolation, the computing device can then warp the real focal length(s) to a fixed virtual focal length that allows the image frame to appear to have a field of view that can be consistent relative to prior and subsequent image frames that are also modified for display via the FOV correction technique. This way, consecutive image frames can be displayed in a manner that appear consistent in FOV and stable despite the image frames actually being captured by the camera when the camera is operating at different real focal lengths.

In some examples, the warping transform used by the computing device is a homography transform that enables the computing device to output preview images of the scene that appear to be from the same perspective with a consistent FOV although the camera is changing focal lengths in-real time to focus upon a target (i.e., performing AF sweeps). In addition to warping the real focal length, the principle point(s) derived for an image frame during camera intrinsic interpolation can be warped to a virtual principle point in some examples. As such, the computing device may apply the warping transform iteratively across scanlines for multiple image frames that occur between the initial preview of the scene and the zoomed preview of the scene as the image capturing device performs the zoom operation.

In examples involving a shutterless camera system, a computing system associated with the camera system can perform camera parameter interpolation to determine a real focal length and a principle point based on the geometric data (e.g., samples of VCM and/or OIS with time stamps) for each scanline in an image frame. In particular, because the camera may use a rolling shutter, the real focal lengths can differ across scanlines. By deriving a and warping real focal lengths on a per-row basis, the FOV correction technique can accommodate the variations that arise due to the sequential readout of scanlines.

In some examples, the computing device may determine a real focal length based on the average focal length of an exposure interval for each scanline in an image frame. For example, for shutterless cameras, the computing system may determine focal lengths using VCM data sampled for each row of the image frame and determine focal length representations that can be mapped to the virtual focal length based on the average focal length during the exposure time. This way, the computing device can perform per-scanline adaption by computing the average VCM readout for each scanline caused by a rolling shutter and then compensate for potential delay between VCM and scanline. In other examples, the real focal length for scanlines in an image frame can be determined in other ways. For instance, the focal length representation for a scanline can be based on the focal length(s) at the middle of an exposure interval.

In some examples, the computing system may perform per-row homography and use backward meshing to refine the output images being displayed. In general, a warping behavior can be described as forward or backward in form. In the forward form, the warp may use a source position to output the destination position that it will be warped to. In the backward form, the warp may obtain a destination position and output the source position that the destination position originates from. As such, in some examples, a computing device may use a backward form of a warp when rendering the display when the final pixel positions are known and the computing device is attempting to determine where the pixels are located on the source image.

In addition, the computing system may use one or more meshes. A mesh is a discretized representation of the warping and can be composed of warped values on the grid vertices. To query the warping out of the grid, interpolation can be applied by a warping engine used by the computing system. The mesh can be used to represent the warping behavior and can be sampled on the discretized grid. The FOV correction warping can be determined as a function of the focal length. By factoring the rolling shuttering effect, the computing device may interpolate the focal length representation per mesh row with the camera intrinsic samples derived previously. The computing system may then generate a FOV correction backward mesh warp. The mesh can be consumed by a warping engine to have the FOV correction effect.

In addition, the computing system may confine the FOV correction backward mesh according to the zoom level. In some instances, the scaling involved in the FOV correction technique may cut-off a portion of the view thereby modifying the real FOV of the camera. As such, the computing system may be configured to apply the FOV correction technique for a portion of zooming sections rather than all zooming sections. For instance, the computing system may be able to turn off FOV correction techniques when the image capturing device is being used to capture full resolution images. This way, the zoom level can be used to limit the application of the FOV correction backward mesh.

In some examples, the computing system may also combine the FOV correction backward mesh with warping mesh from other processing techniques. For example, the computing system may implement multiple warping techniques during operations that can further refine the images output by the computing system.

The following description and accompanying drawings will elucidate features of various example embodiments. The embodiments provided are by way of example, and are not intended to be limiting. As such, the dimensions of the drawings are not necessarily to scale.

### II. Example Systems

As cameras become more popular, they may be employed as standalone hardware devices or integrated into other types of devices. For instance, still and video cameras are now regularly included in wireless computing devices (e.g., smartphones and tablets), laptop computers, wearable computing devices, video game interfaces, home automation devices, and automobiles and other types of vehicles. An image capture component of a camera may include one or more apertures through which light enters, one or more recording surfaces for capturing the images represented by the light, and one or more lenses positioned in front of each aperture to focus at least part of the image on the recording surface(s). The apertures may be fixed size or adjustable.

In an analog camera, the recording surface may be photographic film. In a digital camera, the recording surface may include an electronic image sensor (e.g., a charge coupled device (CCD) or a complementary metal-oxide-semiconductor (CMOS) sensor) to transfer and/or store captured images in a data storage unit (e.g., memory). The image sensor may include an array of photosites configured to capture incoming light through an aperture. When exposure occurs to capture an image, each photosite may collect photons from incoming light and store the photons as an electrical signal. Once the exposure finishes, the camera may close each of the photosites and proceed to measure the electrical signal of each photosite.

The signals of the array of photosites of the image sensor can then be quantified as digital values with a precision that may be determined by the bit depth. Bit depth may be used to quantify how many unique colors are available in an image's color palette in terms of “bits” or the number of 0's and 1's, which are used to specify each color. This does not mean that the image necessarily uses all of these colors, but that the image can instead specify colors with that level of precision. For example, for a grayscale image, the bit depth may quantify how many unique shades are available. As such, images with higher bit depths can encode more shades or colors since there are more combinations of 0's and 1's available.

To capture a scene in a color image, a color filter array (CFA) positioned nearby the image sensor may permit only one color of light from entering into each photosite. For example, a digital camera may include a CFA (e.g., Bayer array) that allows photosites of the image sensor to only capture one of three primary colors (red, green, blue (RGB)). Other potential CFAs may use other color systems, such as a cyan, magenta, yellow; and black (CMYK) array. As a result, the photosites may measure the colors of the scene for subsequent display in a color image.

In some examples, a camera may utilize a Bayer array that consists of alternating rows of red-green and green-blue filters. Within the Bayer array, each primary color does not receive an equal fraction of the total area of the photosite array of the image sensor because the human eye is more sensitive to green light than both red and blue light. Particularly, redundancy with green pixels may produce an image that appears less noisy and more detailed. As such, the camera may approximate the other two primary colors in order to have full color at every pixel when configuring the color image of the scene. For example, the camera may perform Bayer demosaicing or an interpolation process to translate the array of primary colors into an image that contains full color information at each pixel. Bayer demosaicing or interpolation may depend on the image format, size, and compression technique used by the camera.

One or more shutters may be coupled to or nearby the lenses or the recording surfaces. Each shutter may either be in a closed position, in which it blocks light from reaching the recording surface, or an open position, in which light is allowed to reach the recording surface. The position of each shutter may be controlled by a shutter button. For instance, a shutter may be in the closed position by default. When the shutter button is triggered (e.g., pressed), the shutter may change from the closed position to the open position for a period of time, known as the shutter cycle. During the shutter cycle, an image may be captured on the recording surface. At the end of the shutter cycle, the shutter may change back to the closed position.

Alternatively, the shuttering process may be electronic. For example, before an electronic shutter of a CCD image sensor is “opened,” the sensor may be reset to remove any residual signal in its photosites. While the electronic shutter remains open, the photosites may accumulate charge. When or after the shutter closes, these charges may be transferred to longer-term data storage. Combinations of mechanical and electronic shuttering may also be possible. Regardless of type, one or more shutters may be activated and/or controlled by something other than a shutter button. For instance, the shutter(s) may be activated by a softkey, a timer, or some other trigger. Herein, the term “image capture” may refer to any mechanical and/or electronic shuttering process that can result in one or more images being recorded, regardless of how the shuttering process is triggered or controlled.

The exposure of a captured image may be determined by a combination of the size of the aperture, the brightness of the light entering the aperture, and the length of the shutter cycle (also referred to as the shutter length or the exposure length). Additionally, a digital and/or analog gain may be applied to the image, thereby influencing the exposure. In some embodiments, the term “exposure length,” “exposure time,” or “exposure time interval” may refer to the shutter length multiplied by the gain for a particular aperture size. Thus, these terms may be used somewhat interchangeably, and should be interpreted as possibly being a shutter length, an exposure time, and/or any other metric that controls the amount of signal response that results from light reaching the recording surface.

A still camera may capture one or more images each time image capture is triggered. A video camera may continuously capture images at a particular rate (e.g., 24 images—or frames—per second) as long as image capture remains triggered (e.g., while the shutter button is held down). Some digital still cameras may open the shutter when the camera device or application is activated, and the shutter may remain in this position until the camera device or application is deactivated. While the shutter is open, the camera device or application may capture and display a representation of a scene on a viewfinder. When image capture is triggered, one or more distinct digital images of the current scene may be captured.

Cameras may include software to control one or more camera functions and/or settings, such as aperture size, exposure time, gain, and so on. Additionally, some cameras may include software that digitally processes images during or after when these images are captured.

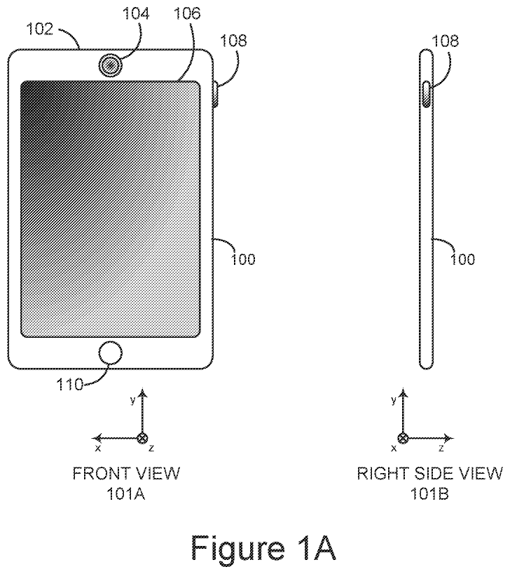

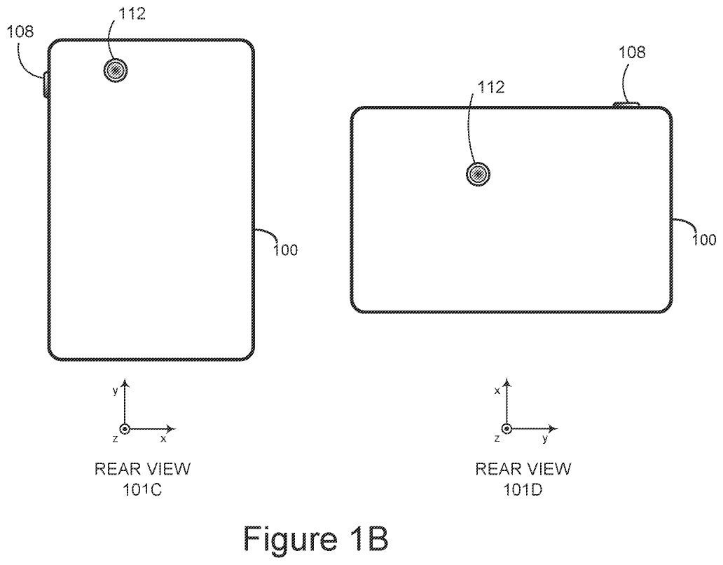

As noted above, digital cameras may be standalone devices or integrated with other devices. As an example, FIG. 1A illustrates the form factor of a digital camera device 100 as seen from a front view 101A and a side view 101B. In addition, FIG. 1B also illustrates the form factor of the digital camera device 100 as seen from a rear view 101C and another rear view 101D. The digital camera device 100 can also be described as a mobile device and may have the form of a mobile phone, a tablet computer, or a wearable computing device. Other embodiments are possible.

As shown in FIGS. 1A and 1B, the digital camera device 100 may include various elements, such as a body 102, a front-facing camera 104, a multi-element display 106, a shutter button 108, and additional buttons 110. The front-facing camera 104 may be positioned on a side of body 102 typically facing a user while in operation, or on the same side as multi-element display 106.

In addition, as depicted in FIG. 1B, the digital camera device 100 further includes a rear-facing camera 112, which is shown positioned on a side of the body 102 opposite from the front-facing camera 104. In addition, the rear views 101C and 101D shown in FIG. 1B represent two alternate arrangements of rear-facing camera 112. Nonetheless, other arrangements are possible. Also, referring to the cameras as front facing or rear facing is arbitrary, and digital camera device 100 may include one or multiple cameras positioned on various sides of body 102.

The multi-element display 106 could represent a cathode ray tube (CRT) display, a light emitting diode (LED) display, a liquid crystal (LCD) display, a plasma display, or any other type of display known in the art. In some embodiments, the multi-element display 106 may display a digital representation of the current image being captured by front-facing camera 104 and/or rear-facing camera 112, or an image that could be captured or was recently captured by any one or more of these cameras. Thus, the multi-element display 106 may serve as a viewfinder for the cameras. The multi-element display 106 may also support touchscreen and/or presence-sensitive functions that may be able to adjust the settings and/or configuration of any aspect of digital camera device 100.

The front-facing camera 104 may include an image sensor and associated optical elements (e.g., lenses) and may offer zoom capabilities or could have a fixed focal length. In other embodiments, interchangeable lenses could be used with the front-facing camera 104. The front-facing camera 104 may have a variable mechanical aperture and a mechanical and/or electronic shutter. The front-facing camera 104 also could be configured to capture still images, video images, or both. The rear-facing camera 112 may be a similar type of image capture component and may include an aperture, lens, recording surface, and shutter. Particularly, the rear-facing camera 112 may operate similarly to the front-facing camera 104.

Either or both of the front-facing camera 104 and the rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover 3D models from an object are possible within the context of the embodiments herein.

In addition, either or both of front-facing camera 104 and/or rear-facing camera 112 may include or be associated with an ambient light sensor that may continuously or from time to time determine the ambient brightness of a scene that the camera can capture. In some devices, the ambient light sensor can be used to adjust the display brightness of a screen associated with the camera (e.g., a viewfinder). When the determined ambient brightness is high, the brightness level of the screen may be increased to make the screen easier to view: When the determined ambient brightness is low; the brightness level of the screen may be decreased, also to make the screen easier to view as well as to potentially save power. The ambient light sensor may also be used to determine exposure times for image capture.

The digital camera device 100 could be configured to use the multi-element display 106 and either the front-facing camera 104 or the rear-facing camera 112 to capture images of a target object. The captured images could be a plurality of still images or a video stream. The image capture could be triggered by activating the shutter button 108, pressing a soft-key on multi-element display 106, or by some other mechanism. Depending upon the implementation, the images could be captured automatically at a specific time interval, for example, upon pressing the shutter button 108, upon appropriate lighting conditions of the target object, upon moving the digital camera device 100 a predetermined distance, or according to a predetermined capture schedule.

In some examples, one or both of the front-facing camera 104 and the rear-facing camera 112 are calibrated monocular cameras. A monocular camera may be an image capturing component configured to capture 2D images. For instance, the monocular camera may use a modified refracting telescope used to magnify the images of distance objects by passing light through a series of lenses and prisms. As such, the monocular cameras and/or other types of cameras may have an intrinsic matrix that can be used for depth estimation techniques presented herein. A camera's intrinsic matrix is used to transform 3D camera coordinates to 2D homogeneous image coordinates.

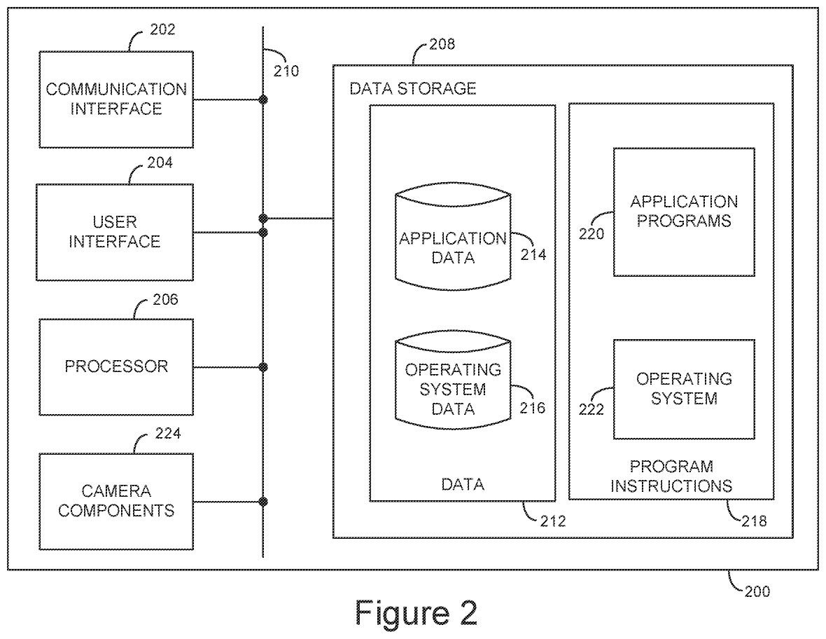

As noted above, the functions of the digital camera device 100 may be integrated into a computing device, such as a wireless computing device, cell phone, tablet computer, wearable computing device, robotic device, laptop computer, vehicle camera, and so on. For purposes of example, FIG. 2 is a simplified block diagram showing some of the components of an example computing system 200 that may include camera components 224.

By way of example and without limitation, the computing system 200 may be a cellular mobile telephone (e.g., a smartphone), a still camera, a video camera, a computer (such as a desktop, notebook, tablet, or handheld computer), a personal digital assistant (PDA), a home automation component, a digital video recorder (DVR), a digital television, a remote control, a wearable computing device, a robotic device, a vehicle, or some other type of device equipped with at least some image capture and/or image processing capabilities. It should be understood that the computing system 200 may represent a physical camera device such as a digital camera, a particular physical hardware platform on which a camera application operates in software, or other combinations of hardware and software that are configured to carry out camera functions.

In the example embodiment shown in FIG. 2, the computing system 200 includes a communication interface 202, a user interface 204, a processor 206, data storage 208, and camera components 224, all of which may be communicatively linked together by a system bus, network, or other connection mechanism 210. The computing system 200 can include other components not shown in FIG. 2.

The communication interface 202 may allow the computing system 200 to communicate, using analog or digital modulation, with other devices, access networks, and/or transport networks. Thus, the communication interface 202 may facilitate circuit-switched and/or packet-switched communication, such as plain old telephone service (POTS) communication and/or Internet protocol (IP) or other packetized communication. For instance, the communication interface 202 may include a chipset and antenna arranged for wireless communication with a radio access network or an access point. Also, the communication interface 202 may take the form of or include a wireline interface, such as an Ethernet, Universal Serial Bus (USB), or High-Definition Multimedia Interface (HDMI) port. The communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)). However, other forms of physical layer interfaces and other types of standard or proprietary communication protocols may be used over the communication interface 202. Furthermore, the communication interface 202 may comprise multiple physical communication interfaces (e.g., a Wi-Fi interface, a BLUETOOTH® interface, and a wide-area wireless interface).

The user interface 204 may function to allow the computing system 200 to interact with a human or non-human user, such as to receive input from a user and to provide output to the user. Thus, the user interface 204 may include input components such as a keypad, key board, touch-sensitive or presence-sensitive panel, computer mouse, trackball, joystick, microphone, and so on. The user interface 204 may also include one or more output components such as one or more display screens which, for example, may be combined with a presence-sensitive panel. The display screen may be based on CRT, LCD, and/or LED technologies, or other technologies now known or later developed. The user interface 204 may also be configured to generate audible output(s), via a speaker, speaker jack, audio output port, audio output device, earphones, and/or other similar devices.

In some embodiments, the user interface 204 may include a display that serves as a viewfinder for still camera and/or video camera functions supported by the computing system 200. Additionally, the user interface 204 may include one or more buttons, switches, knobs, and/or dials that facilitate the configuration and focusing of a camera function and the capturing of images (e.g., capturing a picture). It may be possible that some or all of these buttons, switches, knobs, and/or dials are implemented by way of a presence-sensitive panel.

The processor 206 may include one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with the processor 206. Data storage 208 may include removable and/or non-removable components.

The processor 206 may be capable of executing the program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by the computing system 200, cause the computing system 200 to carry out any of the methods, processes, or operations disclosed in this specification and/or the accompanying drawings. The execution of program instructions 218 by the processor 206 may result in the processor 206 using data 212.

By way of example, the program instructions 218 may include an operating system 222 (e.g., an operating system kernel, device driver(s), and/or other modules) and one or more application programs 220 (e.g., camera functions, address book, email, web browsing, social networking, image applications, and/or gaming applications) installed on the computing system 200. Similarly, data 212 may include operating system data 216 and application data 214. The operating system data 216 may be accessible primarily to the operating system 222, and the application data 214 may be accessible primarily to one or more of the application programs 220. The application data 214 may be arranged in a file system that is visible to or hidden from a user of the computing system 200.

The application programs 220 may communicate with the operating system 222 through one or more application programming interfaces (APIs). These APIs may facilitate, for instance, the application programs 220 reading and/or writing application data 214, transmitting or receiving information via the communication interface 202, receiving and/or displaying information on the user interface 204, and so on.

In some vernaculars, the application programs 220 may be referred to as “apps” for short. Additionally; the application programs 220 may be downloadable to the computing system 200 through one or more online application stores or application markets. However, application programs can also be installed on the computing system 200 in other ways, such as via a web browser or through a physical interface (e.g., a USB port) on the computing system 200.

The camera components 224 may include, but are not limited to, an aperture, shutter, recording surface (e.g., photographic film and/or an image sensor), lens, and/or shutter button. As such, the camera components 224 may be controlled at least in part by software executed by the processor 206. In some examples, the camera components 224 may include one or more image capturing components, such as a monocular camera. Although the camera components 224 are shown as part of the computing system 200, they may be physically separate in other embodiments. For instance, the camera components 224 may capture and provide an image via a wired or wireless connection to the computing system 200 for subsequent processing.

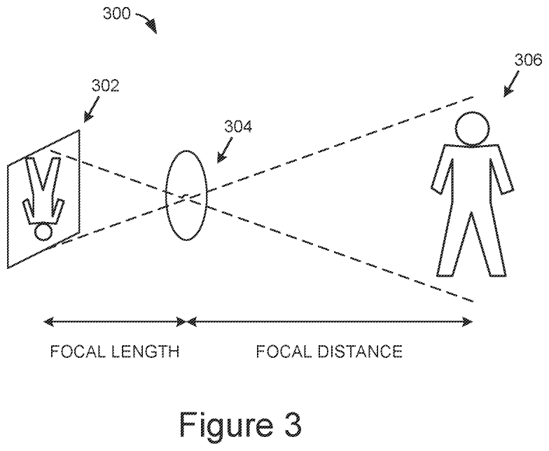

FIG. 3 is a simplified representation of an image capturing component 300 capturing an image of a person 306. The image capturing component 300 includes a recording surface 302 (image sensor) and a lens 304 and may include other components not shown. During image capture, light representing the person 306 and other elements of a scene (not shown) may pass through the lens 304 enabling the image capturing component 300 to subsequently create an image of the person 306 on the recording surface 302. As a result, a display interface connected to the image capturing component 300 may display a digital image of the person 306. In the embodiment shown in FIG. 3, the image of the person 306 appears upside down on the recording surface 302 due to the optics of the lens 304, and an image process technique may invert the image for display.

For some camera configurations, the lens 304 may be adjustable. For instance, the lens 304 may move left or right thereby changing the focal distance of the camera for image capture. The adjustments may be made by applying a voltage to a motor (not shown in FIG. 3) that controls the position of the lens 304 relative to the recording surface 302 enabling the camera to focus on the person 306 at a range of distances. The distance between the lens 304 and the recording surface 302 at any point in time can be referred to as the focal length and may be measured in millimeters or other units. By extension, the distance between the lens 304 and its area of focus can be referred to as the focal distance, which may be similarly measured in millimeters or other units.

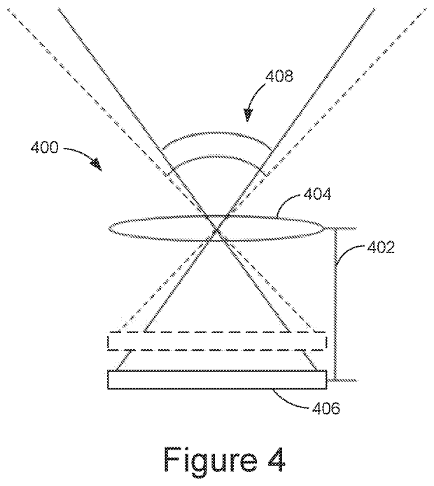

FIG. 4 illustrates imaging hardware performing a zoom operation. In the example embodiment, the focal length 402 is shown as the distance between lens 404 of the camera 400 and the image sensor 406. When the camera 400 performs an AF sweep or another zoom operation, the focal length 402 changes, which in turn adjusts the FOV 408 of the camera. Motors moving the image sensor 406 relative to the lens 404 or other techniques can be used to adjust the focal length 402. The mechanical system of the camera 400 shown in FIG. 4 is coupled with AF software that helps the camera 400 automatically detect where to focus in the scene.

The intrinsic matrix of the camera 400 may be represented as follows:

$$K = [ \begin{matrix}{f}_{x} & 0 & {O}_{x} \\ 0 & {f}_{y} & {O}_{y} \\ 0 & 0 & 1\end{matrix} ] \qquad [ 1 ]$$

Where fₓ and f_{y} to represent the focal lengths in pixels with their values equal when the image has square pixels, and Oₓ and O_{y} are used to represent the position of the principal point on the image sensor 406 of the camera 400. In addition, the matrix shown in equation 1 has the axis skew value set to zero for illustration purposes. A computing system of the camera 400 may use camera intrinsic samples for different frames to perform disclosed FOV correction techniques when the camera 400 performs AF sweeps.

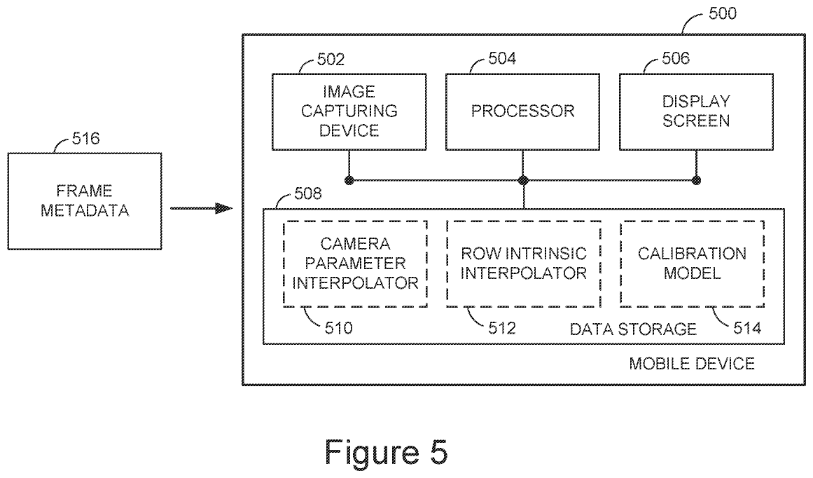

FIG. 5 illustrates a mobile device 500 that may perform FOV correction techniques disclosed herein. The mobile device 500 may take the form of a smartphone or other types of devices that include an image capturing device 502 and associated components for capturing images. In some examples, the mobile device 500 may be implemented as the digital camera device 100 shown in FIGS. 1A-1B and/or include the components of the computing system 200 shown in FIG. 2.

In the example embodiment, the mobile device 500 includes an imaging capturing device 502, a processor 504, a display screen 506, and data storage 508. The data storage can include camera parameter interpolator 510, row intrinsic interpolator 512, and calibration model 514. The data storage 508 can also store other data, such as instructions for performing disclosed FOV correction techniques.

When performing AF sweeps or other zoom-related operations that involve automatic adjustments of the distance between the image sensor and one or more lenses of the image capturing device 502, the mobile device 500 may perform disclosed FOV correction techniques to reduce undesired visual artifacts. For instance, when a target moves into the FOV of the image capturing device as the image capturing device is displaying a preview of the scene on the display screen, the processor 504 or another component may cause the image capturing device 502 to focus on the target. To keep the FOV of image frames displayed on the display screen 506 consistent as the image capturing device 502 performs AF, the mobile device 500 may use a virtual focal length that enables displayed image frames to have a consistent FOV.

The mobile device 500 can use frame metadata 516 to stabilize the FOV among consecutive frames by correcting the real focal length(s) of the image capturing device 502 in each image frame by warping the image from real focal length(s) to a fixed virtual focal length. In this way, the image is virtually captured with the same virtual focal length. The warp can be a homography transform that warps the frame from real focal length to virtual focal length. Homography can allow image frames to be shifted from one view to another of the same scene. As such, the warp transform may be represented as follows:

$$Warp ( {K}_{real} ( t ) , {f}_{virtual} ) = {[ \begin{matrix}{f}_{virtual} & 0 & {o}_{x} ( t ) \\ 0 & {f}_{virtual} & {o}_{y} ( t ) \\ 0 & 0 & 1\end{matrix} ] [ \begin{matrix}{f}_{real} ( t ) & 0 & {o}_{x} ( t ) \\ 0 & {f}_{real} ( t ) & {o}_{y} ( t ) \\ 0 & 0 & 1\end{matrix} ]}^{- 1} = [ \begin{matrix}1 & 0 & {o}_{x} ( t ) \\ 0 & 1 & {o}_{y} ( t ) \\ 0 & 0 & 1\end{matrix} ] [ \begin{matrix}{f}_{virtual} & 0 & 0 \\ 0 & {f}_{virtual} & 0 \\ 0 & 0 & 1\end{matrix} ] {( [ \begin{matrix}1 & 0 & {o}_{x} ( t ) \\ 0 & 1 & {o}_{y} ( t ) \\ 0 & 0 & 1\end{matrix} ] [ \begin{matrix}{f}_{real} ( t ) & 0 & 0 \\ 0 & {f}_{real} ( t ) & 0 \\ 0 & 0 & 1\end{matrix} ] )}^{- 1} = [ \begin{matrix}1 & 0 & {o}_{x} ( t ) \\ 0 & 1 & {o}_{y} ( t ) \\ 0 & 0 & 1\end{matrix} ] [ \begin{matrix}\frac{{f}_{virtual}}{{f}_{real} ( t )} & 0 & 0 \\ 0 & \frac{{f}_{virtual}}{{f}_{real} ( t )} & 0 \\ 0 & 0 & 1\end{matrix} ] {( [ \begin{matrix}1 & 0 & {o}_{x} ( t ) \\ 0 & 1 & {o}_{y} ( t ) \\ 0 & 0 & 1\end{matrix} ] )}^{- 1} \qquad [ 2 ]$$

In the warp shown in equation 2, Kᵣₑₐₗ(t) represents the camera intrinsic at time(t), fᵣₑₐₗ(t) is the focal length at time(t), the optical center at time(t) is represented by oₓ(t) and o_{y}(t), and fᵥᵢᵣₜᵤₐₗ is the time independent virtual focal length. As a result, Kᵥᵢᵣₜᵤₐₗ(t) represents the camera intrinsic with focal length replaced by the virtual focal length. As shown, the warp is similar to a scaling with ratio fᵥᵢᵣₜᵤₐₗ/fᵣₑₐₗ(t) against optical center [oₓ(t), o_{y}(t)].

When performing disclosed FOV correction techniques, the mobile device 500 may obtain and use frame metadata 516 as the image capturing device 502 performs a zoom operation (e.g., AF sweeps) and captures image frame data depicting the scene. The frame metadata 516 can include VCM samples with timestamps and/or optical image stabilization (OIS) samples with timestamps, which can be used by the camera parameter interpolator 510 to produce camera intrinsic data with timestamps. The camera parameter interpolator 510 can use the calibration model 514 to output real focal lengths and principle points for the different image frames, which enables the real focal lengths of the image frames to be warped to a virtual focal length and subsequently displayed by the display screen 506 as image previews with consistent FOVs.

The mobile device 500 can also adapt disclosed techniques when the image capturing device 502 is shutter-less. In particular, when the image capturing device 502 uses an electronic rolling shutter, rows (or columns) of each image may be readout in sequence. The mobile device 500 can consider fᵣₑₐₗ(t) and optical center [oₓ(t), o_{y}(t)] per-row by using row intrinsic interpolator 512. For instance, the representation of fᵣₑₐₗ(t) and optical center [oₓ(t), O_{y}(t)] at row(i) on an image are fᵣₑₐₗ(i), oₓ(i), o_{y}(i), correspondingly. By analyzing focal length and optical center for image rows, the mobile device 500 factors the rolling shutter skew time that arises due to the way the images are read-out in some examples.

In some examples, the mobile device 500 is configured to perform per-row homography and apply a backward mesh. For instance, when the mobile device 500 is attempting to maintain a constant optical center, the mobile device may use a forward mesh and a backward mesh as follows:

$${mesh}_{forward} ( x , y ) = \frac{{f}_{v}}{f ( y )} * ( {p}_{x , y} - {p}_{oc} ) + {p}_{oc} \qquad [ 3 ]$$

$${mesh}_{backward} ( x , y ) = \frac{f ( y )}{{f}_{v}} * ( {p}_{x , y} - {p}_{oc} ) + {p}_{oc} \qquad [ 4 ]$$

In equations 3 and 4, fᵥ represents a virtual focal length, f(y) represents a real focal length, p_{x,y} is the vector (x, y) representing the input point position and p_{oc} is the vector (oₓ(i), O_{y}(i)) representing the optical center. The forward mesh shown in equation 3 can be used by a computing system. In particular, given a source position, equation 3 can be used to output the destination position pixels will be warped to. The backward mesh shown in equation 4 can be used by the computing system in some examples. Given a destination position, the backward mesh shown in equation 4 can output the source position that the destination position comes from. For example, the backward mesh can be used to render the display since the computing system has data indicating where the final pixel is to display and is attempting to know where it is on the source image.

In some examples, the mobile device 500 may use a dynamic setting to turn the FOV correction technique on or off based on the zoom level. For instance, the confinement on the warping could be represented as follows:

$${Warp}_{confined} = ( 1 - c ( z ) ) * ( \frac{f ( y )}{{f}_{v}} ) + c ( z ) \qquad [ 5 ]$$

where c(z) is a confinement term range in [0, 1], which is a function of zoom level z and I is an identical warp transformation. This is equivalent to confine the focal length, which could be integrated in the backward mesh to produce the following:

$$( \frac{f ( y )}{{f}_{v}} ) confined = ( 1 - c ( z ) ) * ( \frac{f ( y )}{{f}_{v}} ) + c ( z ) \qquad [ 6 ]$$

As such, the FOV correction backward mesh can be combined with warping mesh from other processing. Meshes could be concatenated sequentially in some examples. For instance, mesh from other processing techniques may provide functionality like lens distortion correction, stabilization, face un-distortion, etc.

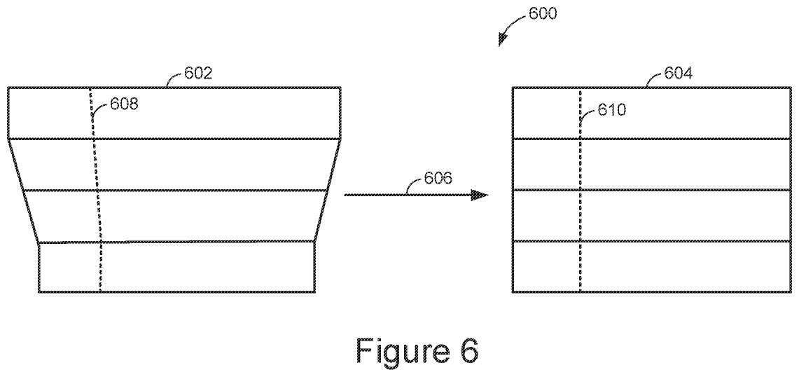

FIG. 6 represents a comparison between a camera view with and without the application of the FOV rolling shutter correction. In particular, the comparison 600 shows the real camera view 602 that represents the display that the mobile device 500 may output without an application of the FOV rolling shutter correction technique and the virtual camera view 604 after the application of the FOV rolling shutter correction technique 606. In the comparison 600, the different outputs show the scaling difference per-scanline. As shown, the bending line 608 in the real camera view 602 may become a straight line 610 as a representation of scaling difference per-scanline after the application of the FOV rolling shutter correction technique 606.

### III. Example Methods

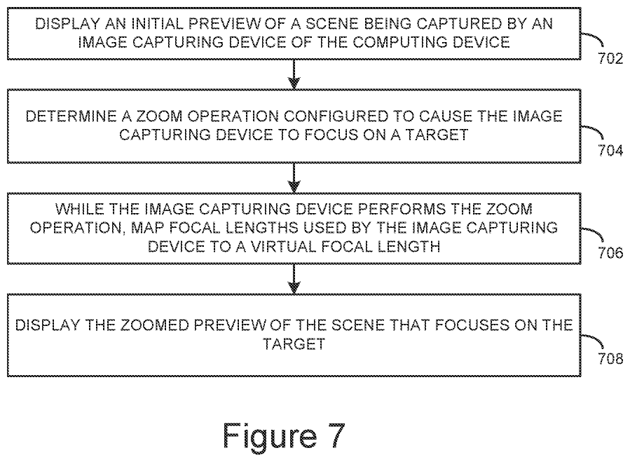

FIG. 7 is a flow chart, according to example embodiments. The embodiment illustrated by FIG. 7 may be carried out by a computing system, such as the digital camera device 100 shown in FIG. 1 or the mobile device 500 shown in FIG. 5. The embodiment, however, can also be carried out by other types of devices or device subsystems, such as by a computing system positioned remotely from a camera. Further, the embodiment may be combined with any aspect or feature disclosed in this specification or the accompanying drawings.

At block 702, method 700 involves displaying, by a display screen of a computing device, an initial preview of a scene being captured by an image capturing device of the computing device. The image capturing device is operating at an initial focal length when capturing the initial preview of the scene. In some examples, the image capturing device is a shutterless camera system.

At block 704, method 700 involves determining, by the computing device, a zoom operation configured to cause the image capturing device to focus on a target. In some examples, the image capturing device is configured to change focal length when performing the zoom operation. For example, the computing device may cause the image capturing device to perform an AF technique to focus on a target.

At block 706, method 700 involves while the image capturing device performs the zoom operation, mapping focal lengths used by the image capturing device to a virtual focal length such that a field of view of the scene remains consistent across image frames displayed by the display screen between the initial preview of the scene and a zoomed preview of the scene that focuses on the target. In some examples, the computing system may determine the virtual focal length based on the initial focal length. In other examples, the computing system may obtain a calibration model for the image capturing device and determine the virtual focal length based on the calibration model for the image capturing device. The computing system may then compute a scaling ratio between a given focal length for an image frame and the virtual focal length and then apply the scaling ratio to map focal length to the virtual focal length.

In some examples, the computing system may obtain frame-based data for each image frame while the image capturing device performs the zoom operation and determines geometric data for the image capturing device based on the frame-based data for each image frame. The frame-based data may include VCM data in some examples. In other examples, the frame-based data may further include OIS data. As such, the computing system may then apply a warping transform configured to map a focal length determined for an image frame to the virtual focal length where the focal length is determined for the image frame based on the geometric data corresponding to the image frame.

In some examples, mapping the focal lengths involves determining a real focal length used by the image capturing device for an image frame based on the VCM data corresponding to the image frame, and applying a warping transform that maps the real focal length determined for the image frame to the virtual focal length. Determining the real focal length can involve determining a set of real focal lengths corresponding to scanlines in the image frame. For instance, a real focal length for a scanline in the image frame can be determined based on an average focal length of an exposure interval for the scanline. In other instances, a real focal length for a scanline in the image frame may be determined based on a given focal length at a middle of an exposure interval for the scanline. As such, the computing system may then apply the warping transform to map each real focal length from the set of real focal lengths to the virtual focal length.

In some examples, the computing system may obtain frame-based data representing intrinsic parameters corresponding to the image capturing device. The frame-based data can include timestamps. As such, the computing system may then interpolate a focal length representation per mesh row based on the frame-based data. In some examples, the computing system may generate a backward mesh warp based on the focal length representation per mesh row and apply the backward mesh warp for a given image frame. The process can be iteratively performed.

In some examples, the computing system may detect the target in the scene based on one or more visual features in one or more image frames being captured by the image capturing device. The one or more image frames are subsequent to the initial preview of the scene. The computing system may determine the zoom operation responsive to detecting the target.

At block 708, method 700 involves displaying, by the display screen of the computing device, the zoomed preview of the scene that focuses on the target. In some examples, the computing system may display the image frames between the initial preview of the scene and the zoomed preview while the image capturing device performs the zoom operation. Applying the warping transform can reduce one or more viewing artifacts that occur when the image capturing device performs the zoom operation.

In some examples, the computing system may generate, for each frame, a bundle adjustment to be applied to one or more camera calibrations and one or more focal distances. The computing system may then generate, for a collection of successive frames, a modified bundle adjustment based on respective bundle adjustments of the successive frames. The computing system may also detect one or more visual features in the initial preview and the zoomed preview, and then generate, based on the one or more visual features, an image-based visual correspondence between the initial preview and the zoomed preview:

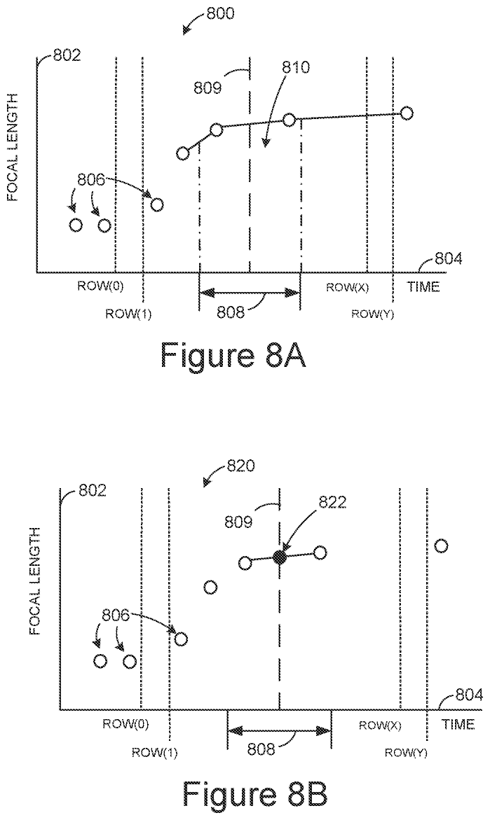

In some examples, the computing system may determine an average focal length of an exposure interval for an image frame and apply the warping transform to map the average focal length of the exposure interval for the image frame to the virtual focal length. As an example, FIG. 8A illustrates a focal length representation based on an average focal length of an exposure interval. The computing device may interpolate the focal length representation per mesh row by determining the focal length representation based on an average focal length in an exposure interval.

In the example embodiment shown in FIG. 8A, the graph 800 shows focal length on the Y-axis 802 relative to time on the X-axis 804 with focal length samples 806. The exposure time 808 for the image frame is shown with the rows arranged relative to time representing a rolling shutter example. As further shown, the computing device may interpolate focal length for row(n) 809 based on the average focal length in the area 810 that extends across the exposure time 808.

In some examples, the computing system may determine focal length representation for an image frame based on the middle of the exposure level. As an example, FIG. 8B illustrates a focal length representation determined based on focal lengths at the middle of an exposure interval. The computing device may interpolate the focal length representation per mesh row by determining the focal length representation based on a middle focal length in an exposure interval.

In the example embodiment shown in FIG. 8B, the graph 820 is similar to the graph 800 with focal length represented on the Y-axis 802 and time represented on the X-axis 804. The graph 820 further includes the same focal length samples 806 that each have a focal length depending on time. As shown in FIG. 8B, in some examples, the computing device may interpolate the focal length for row(n) 809 based on the focal length 822 determined for the middle of the exposure interval 808.

### IV. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrent or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

Additionally, any enumeration of elements, blocks, or steps in this specification or the claims is for the purpose of clarity. Thus, such enumeration should not be interpreted to require or imply that these elements, blocks, or steps adhere to a particular arrangement or are carried out in a particular order.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

What is claimed is:

1. A computer-implemented method, comprising:
displaying, by a display screen of a computing device, an initial preview of a scene being captured by an image capturing device of the computing device, wherein the image capturing device is operating at an initial focal length when capturing the initial preview of the scene;
determining, by the computing device, a zoom operation configured to cause the imaging capturing device to focus on a target, wherein the imaging capturing device is configured to change focal length when performing the zoom operation;
while the image capturing device performs the zoom operation, mapping focal lengths used by the imaging capturing device to a virtual focal length such that a field of view of the scene remains consistent across image frames displayed by the display screen between the initial preview of the scene and a zoomed preview of the scene that focuses on the target; and
displaying, by the display screen, the zoomed preview of the scene that focuses on the target.

2. The method of claim 1, further comprising:
obtaining frame-based data for each image frame while the image capturing device performs the zoom operation; and
determining geometric data for the image capturing device based on the frame-based data for each image frame.

3. The method of claim 2, wherein frame-based data comprises voice coil motor (VCM) data.

4. The method of claim 3, wherein mapping the focal lengths used by the image capturing device to the virtual focal length comprises:
determining a real focal length used by the image capturing device for an image frame based on the VCM data corresponding to the image frame; and
applying a warping transform that maps the real focal length determined for the image frame to the virtual focal length.

5. The method of claim 4, wherein determining the real focal length comprises:
determining a set of real focal lengths corresponding to scanlines in the image frame, wherein a real focal length for a scanline in the image frame is determined based on an average focal length of an exposure interval for the scanline.

6. The method of claim 5, wherein applying the warping transform comprises:
applying the warping transform to map each real focal length from the set of real focal lengths to the virtual focal length.

7. The method of claim 4, wherein determining the real focal length comprises:
determining a set of real focal lengths corresponding to scanlines in the image frame, wherein a real focal length for a scanline in the image frame is determined based on a given focal length at a middle of an exposure interval for the scanline.

8. The method of claim 7, wherein applying the warping transform comprises:
applying the warping transform to map each real focal length from the set of real focal lengths to the virtual focal length.

9. The method of claim 1, wherein determining the zoom operation configured to cause the image capturing device to focus on the target comprises:
causing the image capturing device to perform an auto focus (AF) technique.

10. The method of claim 1, further comprising:
obtaining frame-based data representing intrinsic parameters corresponding to the image capturing device, wherein frame-based data includes timestamps; and
based on the frame-based data, interpolating a focal length representation per mesh row.

11. The method of claim 10, wherein interpolating the focal length representation per mesh row comprises:
determining the focal length representation based on an average focal length in an exposure interval.

12. The method of claim 10, wherein interpolating the focal length representation per mesh row comprises:
determining the focal length representation based on a middle focal length in an exposure interval.

13. The method of claim 10, wherein mapping focal lengths used by the image capturing device to the virtual focal length comprises:
generating a backward mesh warp based on the focal length representation per mesh row; and
applying the backward mesh warp for a given image frame.

14. The method of claim 1, further comprising:
detecting the target in the scene based on one or more visual features in one or more image frames being captured by the image capturing device, wherein the one or more image frames are subsequent to the initial preview of the scene; and
wherein determining the zoom operation comprises:
determining the zoom operation responsive to detecting the target.

15. The method of claim 1, further comprising:
determining the virtual focal length based on the initial focal length.

16. The method of claim 1, further comprising:
obtaining a calibration model for the image capturing device; and
determining the virtual focal length based on the calibration model for the image capturing device.

17. The method of claim 16, wherein mapping focal lengths used by the image capturing device to the virtual focal length comprises:
computing a scaling ratio between a given focal length for an image frame and the virtual focal length; and
applying the scaling ratio.

18. A mobile device comprising:
a display screen;
an image capturing device;
one or more processors; and
data storage, wherein the data storage has stored thereon computer-executable instructions that, when executed by the one or more processors, cause the mobile device to carry out functions comprising:
displaying, by the display screen, an initial preview of a scene being captured by the image capturing device, wherein the image capturing device is operating at an initial focal length when capturing the initial preview of the scene;
determining a zoom operation configured to cause the imaging capturing device to focus on a target, wherein the imaging capturing device is configured to change focal length when performing the zoom operation;
while the image capturing device performs the zoom operation, mapping focal lengths used by the imaging capturing device to a virtual focal length such that a field of view of the scene remains consistent across image frames displayed by the display screen between the initial preview of the scene and a zoomed preview of the scene that focuses on the target; and
displaying, by the display screen, the zoomed preview of the scene that focuses on the target.

19. The mobile device of claim 18, wherein the image capturing device is a shutterless camera system.

20. A non-transitory computer-readable medium comprising program instructions executable by one or more processors to cause the one or more processors to perform operations comprising:
displaying, by a display screen, an initial preview of a scene being captured by an image capturing device, wherein the image capturing device is operating at an initial focal length when capturing the initial preview of the scene;
determining a zoom operation configured to cause the imaging capturing device to focus on a target, wherein the imaging capturing device is configured to change focal length when performing the zoom operation;
while the image capturing device performs the zoom operation, mapping focal lengths used by the imaging capturing device to a virtual focal length such that a field of view of the scene remains consistent across image frames displayed by the display screen between the initial preview of the scene and a zoomed preview of the scene that focuses on the target; and
displaying, by the display screen, the zoomed preview of the scene that focuses on the target.
